(19) United States
(12) Patent Application Publication
(10) Pub. No.: US 2016/0025323 A1
(43) Pub. Date: Jan. 28, 2016

(54) LAMP WITH AN OVERHEAT PROTECTION DEVICE

(71) Applicant: Genius Electronic Optical Co., Ltd., Taichung City (TW)

(72) Inventor: Chih-Shen LIN, Taichung City (TW)

(21) Appl. No.: 14/793,745

(22) Filed: Jul. 8, 2015

(30) Foreign Application Priority Data
Jul. 22, 2014 (TW) 103125092

(51) Int. Cl. F21V 29/85; F21V 29/15

(52) U.S. Cl. CPC F21V 29/85; F21V 29/15; F21Y 2101/02

(57) ABSTRACT

A lamp with an overheat protection device includes: a housing, a base board, an overheat protection unit and a LED. The LED of the present invention is disposed on the base board, and the overheat protection unit has the heat conduction surface directly abutted against the base board. When the LED overheats, heat energy can be transmitted to the base board then transmitted to the overheat protection unit, so that the overheat protection unit can be heated quickly and directly to reduce reaction time, which prevents the LED from overheating.

### CROSS REFERENCE TO RELATED APPLICATION

This application claims the benefit of priority to TW 103125092, filed on Jul. 22, 2014 with the Intellectual Property Office of the Republic of China, Taiwan, the entire specification of which is incorporated herein by reference.

### BACKGROUND OF THE INVENTION

1. Field of the Invention

The present invention relates to a lamp, and more particularly to a lamp with an overheat protection device.

2. Description of the Prior Art

LED (light emitting diode) lamps have been widely used due to its advantages of low power consumption and long life. High power high brightness LED lamp is one of the LED lamps, although high power LED lamp can produce high brightness, it also produces a large amount of heat.

The high power LED lamp is normally provided with heat dissipation fins and an overheat protection device. The overheat protection device includes PTC (positive temperature coefficient) Thermistors disposed in a ceramic housing, and two external terminals through which the PTC Thermistors can be connected to the circuit board to establish electric connection with the LED or other components. When the LED or other components are overheated to cause overheat of the circuit board, the PTC Thermistors will increase resistance to reduce the current of the circuit board, or even turn off the LEDs or other components on the circuit board.

However, since the PTC Thermistors are covered in the ceramic housing, the ambient temperature of the circuit board is conducted by air to the housing then to the PTC Thermistors. The heat conduction process is indirect and reaction is slow, which does not satisfy the high heat dissipation demand of the high power LED lamp.

The present invention has arisen to mitigate and/or obviate the afore-described disadvantages.

### SUMMARY OF THE INVENTION

The present invention is aimed at providing a lamp with an overheat protection device which is free of the disadvantage of slow reaction of the conventional overheat protection device of the high power LED lamp.

Therefore, a lamp with an overheat protection device in accordance with the present invention includes:

a housing;

a base board disposed in the housing;

an overheat protection unit with a heat conduction surface abutted against the base board; and

at least one light emitting diode disposed on the base board and electrically connected to the overheat protection unit.

The LED of the present invention is disposed on the base board, and the overheat protection unit has the heat conduction surface directly abutted against the base board. When the LED is overheated, heat energy can be transmitted to the base board then transmitted to the overheat protection unit, so that the overheat protection unit can be heated quickly and directly to reduce reaction time, which prevents the LED from overheat.

### BRIEF DESCRIPTION OF THE DRAWINGS

FIG. 1 is a cross sectional view of a lamp with an overheat protection device in accordance with the present invention;

FIG. 2 is a plan view of a part of FIG. 1;

FIG. 3 is a cross sectional view of a lamp with an overheat protection device in accordance with another embodiment of the present invention; and

FIG. 4 is an enlarged view of a part of FIG. 3.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

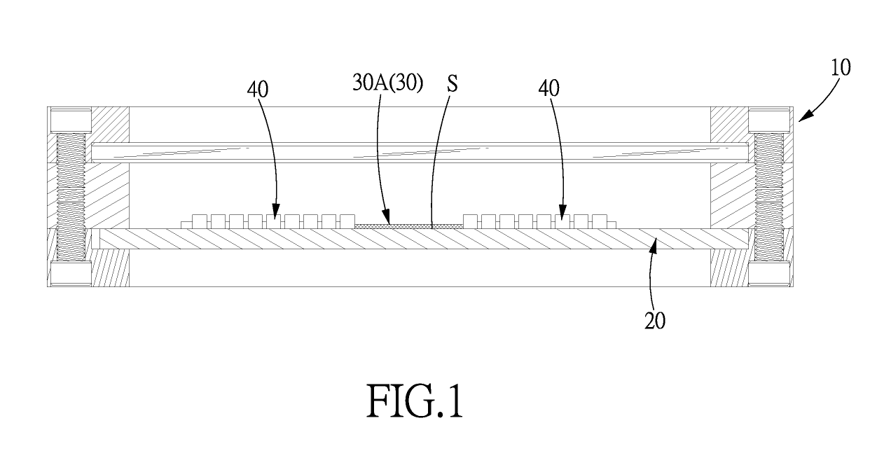

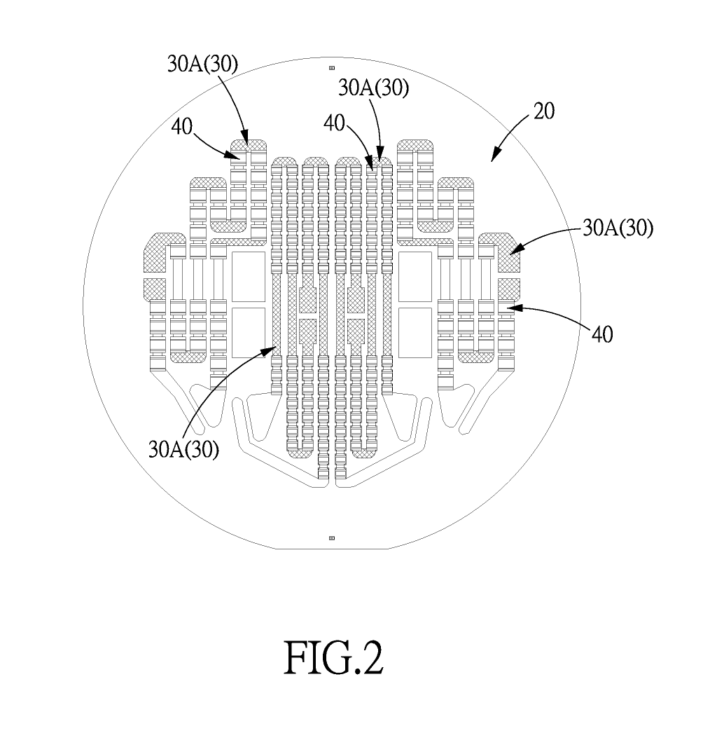

Referring to FIGS. 1-2, a lamp with an overheat protection device in accordance with the present invention includes: a housing 10, a base board 20, an overheat protection unit 30 and a LED (light emitting diode) 40.

The base board 20 is disposed in the housing 10.

The overheat protection unit 30 includes a heat conduction surface S abutted against the base board 20. The overheat protection unit 30 can be as shown in FIGS. 1 and 2, wherein the overheat protection unit 30A is made of PTC (positive temperature coefficient) thermistor material and can be screen printed on the base board 20 to become a circuit. The thermistor material can be oxide sinter containing BaTiO3, SrTiO3 or PbTiO3 mixed with micro amount of Nb, Ta, Bi, Sb, La, Mn, Fe, Cu or Cr5.

The LED 40 is disposed on the base board 20 and electrically connected to the overheat protection unit 30A. There can be one or plurality of LEDs.

The overheat protection unit 30A and the LED 40 cooperate with a power source to form a circuit. When the LED 40 is overheated, the heat energy of the LED 40 can be transmitted to the base board 20 directly. Since the overheat protection unit 30A has the heat conduction surface S abutted against the base board 20, the heat of the base board 20 can be transmitted directly to the overheat protection unit 30A via the heat conduction surface S. The overheat protection unit 30A is made of PTC thermistor material, the resistance value will be increased when the overheat protection unit 30A is heated, as a result, the current value of the LED 40 which is electrically connected to the overheat protection unit 30A will be decreased to switch off the LED 40, so as to prevent overheat of the LED 40.

It is to be noted that the overheat protection unit 30A has the heat conduction surface S abutted against the base board 20, the surface-to-surface contact improves heat conduction efficiency, which consequently reduces the reaction time of the overheat protection unit 30. Besides, as shown in FIGS. 1 and 2, the overheat protection unit 30A is screen printed on the base board 20, so that the degree of freedom of the position and arrangement of the overheat protection unit 30A is enhanced, which also facilitates to the arrangement of LED 40 and other components on the base board 20, so as to improve inconvenience and freedom of assembly. The position of the overheat protection unit 30A includes, but not limited to, the position as shown in FIG. 2, the overheat protection unit 30A can be electrically connected to part of or all the LEDs 40.

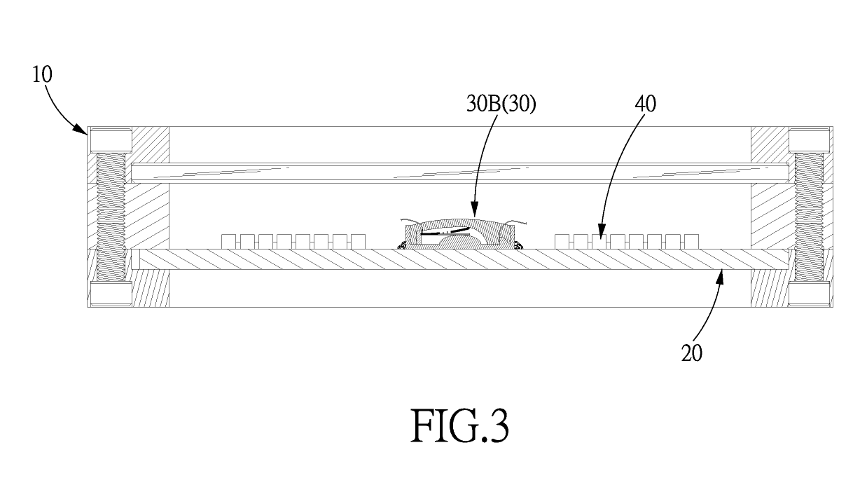

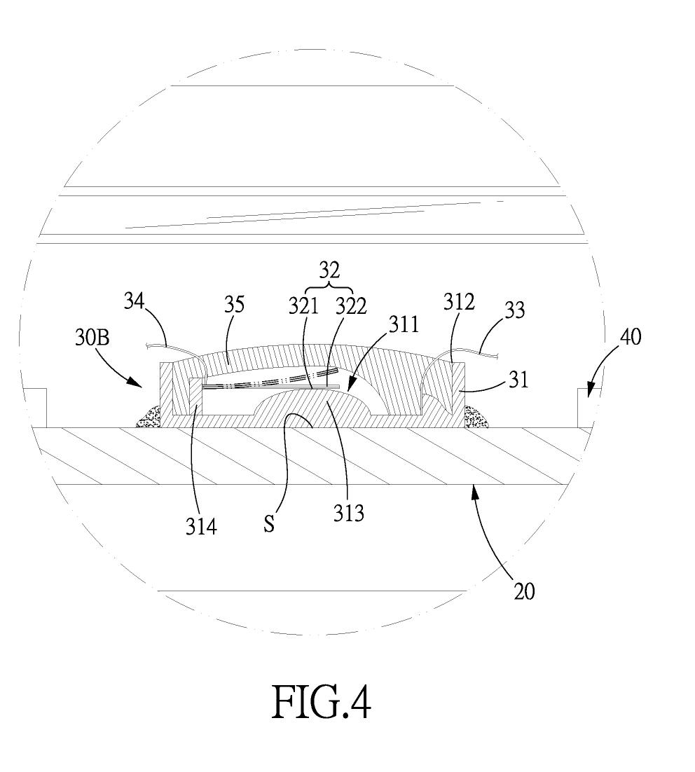

FIGS. 3 and 4 show another embodiment of the lamp with an overheat protection device in accordance with the present invention, wherein the overheat protection unit 30B includes: a first terminal 31, a second terminal 32, a first external terminal 33, a second external terminal 34, and an insulator 35.

The first terminal 31 is formed with a chamber 311 and a heat conduction surface S. The chamber 311 includes an opening 312. In the chamber 311 are disposed a convex portion 313 and an insulator-fixing member 314, and the heat conduction surface S of the first terminal 31 is abutted against the base board 20.

The second terminal 32 is formed by pressing two metal sheets with different expansion coefficients together, and has one end fixed to the insulator-fixing member 314 and another end removably pressed against the convex portion 313 of the first terminal 31. In this embodiment, the second terminal 32 includes a first metal sheet 321 and a second metal sheet 322 which are pressed against each other, the first metal sheet 321 has an expansion coefficient larger than the expansion coefficient of the second metal sheet 322, and the second terminal 32 has the metal sheet with the larger expansion coefficient is removably brought into contact with the convex portion 313 of the first terminal 31, namely, the first metal sheet 321 comes into contact with the first terminal 31. In this embodiment, the first metal sheet 321 is made of aluminum, and the second metal sheet 322 can be made of, but not limited to platinum. Changing the materials of the two metal sheets of the second terminal 32 may change reaction time, such modification can be made without departing from the scope of the present invention.

The first external terminal 33 has one end electrically connected to the first terminal 31.

The second external terminal 34 has one end electrically connected to the second terminal 32.

The insulator 35 covers the first and second terminals 31, 32 and seals the opening 312 of the chamber 311 of the first terminal 31. Another end of the first external terminal 33 or another end of the second external terminal 34 extends out of the insulator 35 and is electrically connected to the LED 40.

The overheat protection unit 30 can also be used as shown in FIG. 3, wherein the overheat protection unit 30 and the LED 40 cooperate with a power source to form a circuit. When the LED 40 is overheated, the heat energy of the LED 40 can be transmitted to the base board 20 directly. Since the overheat protection unit 30B has the heat conduction surface S abutted against the base board 20, the heat of the base board 20 can be transmitted directly to the first terminal 31 of the overheat protection unit 30B via the heat conduction surface S. meanwhile, temperature is transmitted to the second terminal 32 which comes into contact with the convex portion 313 of the first terminal 31. When the second terminal 32 is heated, since it is made of two metal sheets with different expansion coefficients, and the second terminal 32 has the metal sheet with the larger expansion coefficient abutted against the first terminal 31, the two metal sheets will expand to different degrees, so that the second terminal 32 will be bent toward the first terminal 31. When the second terminal 32 is bent, the metal sheet with larger expansion coefficient will be bent toward the metal sheet with smaller expansion coefficient, which makes the second terminal 32 disengage from the convex portion 313 of the first terminal 31, namely, the first terminal 31 is cut off from the second terminal 32, and the whole circuit is also cut off, and as a result, the LED 40 is turned off to prevent overheat.

It is learned from the above description that the LED 40 of the present invention is disposed on the base board 20, and the overheat protection unit 30 has the heat conduction surface S directly abutted against the base board 20. When the LED 40 is overheated, heat energy can be transmitted to the base board 20 then transmitted to the overheat protection unit 30, so that the overheat protection unit 30 can be heated quickly and directly to reduce reaction time, which prevents the LED 40 from overheat. In addition, the base board 20 is an insulator, and the first terminal 31 is welded to the base board 20 to become an independent and closed metal circuit, therefore, the first terminal 31 can be prevented from short circuit and keeps conducting heat quickly.

While we have shown and described various embodiments in accordance with the present invention, it is clear to those skilled in the art that further embodiments may be made without departing from the scope of the present invention.

What is claimed is:

1. A lamp with an overheat protection device comprising:
a housing;
a base board disposed in the housing;
an overheat protection unit with a heat conduction surface abutted against the base board;
at least one light emitting diode disposed on the base board and electrically connected to the overheat protection unit.

2. The lamp with the overheat protection device as claimed in claim 1, wherein the overheat protection unit is made of positive temperature coefficient thermistor material.

3. The lamp with the overheat protection device as claimed in claim 2, wherein the overheat protection unit is screen printed on the base board.

4. The lamp with the overheat protection device as claimed in claim 1, wherein a plurality of said light emitting diodes are disposed on the base board.

5. The lamp with the overheat protection device as claimed in claim 1, wherein the overheat protection unit comprises a first terminal, a second terminal, a first external terminal, a second external terminal, the first terminal includes the heat conduction surface, and the second terminal is formed by pressing two metal sheets with different expansion coefficients together and has one end fixed to an insulator-fixing member and another end removably pressed against the first terminal.

6. The lamp with the overheat protection device as claimed in claim 5, wherein the first terminal is electrically connected to one end of a first external terminal, the second terminal is electrically connected to one end of a second external terminal, another end of the first or second external terminal is electrically connected to the light emitting diode.

7. The lamp with the overheat protection device as claimed in claim 6, wherein the overheat protection unit further includes an insulator which covers the first and second terminals, another end of the first terminal or another end of the second terminal extends out of the insulator and is electrically connected to the light emitting diode.

8. The lamp with the overheat protection device as claimed in claim 5, wherein the first terminal is formed with a chamber which includes an opening, in the chamber are disposed a convex portion and the insulator-fixing member, the second terminal has another end removably pressed against the convex portion of the first terminal, and the overheat protection unit further comprises an insulator to seal the opening.
